(19) United States
(12) Patent Application Publication
(10) Pub. No.: US 2018/0104897 A1
(43) Pub. Date: Apr. 19, 2018

(54) BUILD TEMPERATURE MODULATION

(71) Applicant: Hewlett-Packard Development Company, L.P., Houston, TX (US)

(72) Inventor: Michael A. NOVICK, San Diego, CA (US)

(73) Assignee: Hewlett-Packard Development Company, L.P., Houston, TX (US)

(21) Appl. No.: 15/567,339

(22) PCT Filed: Jun. 10, 2015
(86) PCT No.: PCT/US2015/035168

§ 371 Date: Oct. 17, 2017

(51) Int. Cl. B29C 64/386; B33Y 50/02

(52) U.S. Cl. CPC B29C 64/386; B33Y 50/02

(57) ABSTRACT

According to an example, build temperature modulation may include determining a characteristic of an object to be produced by three-dimensional printing. The three-dimensional printing may divide the object into a plurality of printing areas for producing the object by using a fusing agent. The build temperature modulation may further include determining, based on the characteristic of the object to be produced by the three-dimensional printing, a fusing agent flux amount of the fusing agent sufficient to oversaturate a printing area of the plurality of printing areas to modulate temperatures related to the plurality of printing areas to a substantially constant temperature across the plurality of printing areas.

### BACKGROUND

Three-dimensional printing may include any of a variety of processes to produce a three-dimensional object. The three-dimensional object may be of almost any shape or geometry, and is typically produced from a three-dimensional model or other electronic data source. In three-dimensional printing, additive processes are often used to produce the three-dimensional object by placement, or solidification, of successive layers, or portions of layers, of material under computer control.

### BRIEF DESCRIPTION OF DRAWINGS

Features of the present disclosure are illustrated by way of example and are not limited in the following figure(s), in which like numerals indicate like elements, in which:

FIG. 1 illustrates an architecture of an apparatus for build temperature modulation, according to an example of the present disclosure;

FIG. 2 illustrates three-dimensional objects disposed in vertical and horizontal orientations, according to an example of the present disclosure;

FIG. 3 illustrates an image of a thermal slice of the objects of FIG. 2, and a graph of related temperature variation, according to an example of the present disclosure;

FIG. 4 illustrates an image of a thermal slice of the objects of FIG. 2, and a graph of related temperature variation based on increased fusing agent flux, according to an example of the present disclosure;

FIG. 5 illustrates three-dimensional objects including the same diameter, but printed at varying contone levels, according to an example of the present disclosure;

FIG. 6 illustrates a graph of temperature versus contone level, according to an example of the present disclosure;

FIG. 7 illustrates three-dimensional objects of different diameters, according to an example of the present disclosure;

FIG. 8 illustrates a table of temperature versus diameter for the three-dimensional objects of FIG. 7, when printed at a constant contone level and corresponding temperature delta, according to an example of the present disclosure;

FIG. 9 illustrates a graph of temperature versus diameter for the three-dimensional objects of FIG. 7, according to an example of the present disclosure;

FIG. 10 illustrates a table of temperature versus diameter for the three-dimensional objects of FIG. 7, when printed at the varying contone levels shown, according to an example of the present disclosure;

FIG. 11 illustrates a graph of temperature versus diameter for the three-dimensional objects of FIG. 7, when printed at the varying contone levels shown in FIG. 10, according to an example of the present disclosure;

FIG. 12 illustrates a method for build temperature modulation, according to an example of the present disclosure;

FIG. 13 illustrates further details of the method for build temperature modulation, according to an example of the present disclosure;

FIG. 14 illustrates further details of the method for build temperature modulation, according to an example of the present disclosure; and

FIG. 15 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

With respect to three-dimensional printing, certain types of printing technology may depend on jetting of fusing and detailing agents (i.e., inks) over areas of un-solidified powder (e.g., white nylon powder), followed by exposure to fusing lamps to selectively melt layers of a part of a three-dimensional object that is to be produced. The fusing agent may generally include the printing fluid (e.g., black ink) that absorbs energy from the fusing lamps. The detailing agent may provide for the control of temperatures around the boundaries of areas printed by the fusing agent, or may modulate the effect of a fusing agent. The detailing agent may include, for example, a clear fluid, or fluids of different colors.

In order to produce a solid three-dimensional object, certain areas of the un-solidified powder may be printed with the fusing and detailing agents. The printed areas may be irradiated, for example, with the fusing lamps, and based on the proper application of irradiation, the printed areas that include the fusing agent may effectively melt before the surrounding un-solidified powder. If the amount of irradiation is not properly controlled, too much of the printed areas and surrounding un-solidified powder may melt, or the printed areas may not melt sufficiently. For example, when a printed area is selectively melted, smaller areas may tend to cool faster than larger areas, resulting in potentially weaker mechanical properties in the smaller areas.

In general, as more fusing agent is applied, the resulting blacker (e.g., based on the use of black fusing agent, or colored, based on the use of colored fusing agent) printed surface may absorb more of the fusing lamp energy and result in greater melting of each layer. However, compared to larger printed areas, smaller printed areas may lose heat to surrounding areas relatively faster, thus reducing the material properties (e.g., strength, modulus, percent elongation, etc.) of the smaller printed areas. In order to address these aspects, the overall build temperatures used for producing an object may be increased, and optical density of the relatively larger printed areas may be reduced so that the larger printed areas do not overcook (i.e., melt more than needed). With respect to reducing the optical density of the relatively larger areas by reducing the fusing agent applied, adjusting the fusing agent flux may produce a relatively weak temperature response. Adjusting the optical density on different sized areas may also result in color variations on the surfaces. Further, the larger, lighter-covered areas may receive less of any material property enhancers (e.g., materials needed to maintain properties, such as, tensile strength, etc.) added to the fusing agent. Larger, lighter-covered areas may also be more susceptible to clogged nozzles due to a reduction in the amount of fusing agent being applied through a nozzle. For example, clogged nozzles may result in a streak of unfused powder produced on an object, which may result in weakening of the material properties of the object. Moreover, when adjusting the optical density fails to maintain level temperatures, for example, within ±1° C., the thermal bleed may increase around excessively hot areas.

In order to address the aforementioned aspects related to three-dimensional printing, an apparatus for build temperature modulation and a method for build temperature modulation are disclosed. The apparatus and method disclosed herein may generally provide for oversaturating of the larger printed areas to cool the larger printed areas such that overall hotter conditions may be used to melt smaller printed areas equally as well as the larger printed areas. Compared to optical density modulation, oversaturating of the larger printed areas may use the evaporative cooling potential of fluid to cool the larger printed areas.

The evaporative cooling implemented by the apparatus and method disclosed herein may also be used in conjunction with application of a detailing agent around, instead of on top of the object being printed. In this regard, the detailing agent may reduce the temperature of areas and thermal bleed as needed by producing cooler heat sinks around part profiles.

With respect to increasing the fluid flux over larger areas as described for the apparatus and method disclosed herein, beyond a certain point (e.g., a threshold fusing agent lower flux amount of fusing agent flux), adding more fusing agent may increase the evaporative cooling effect more than any change in absorptivity. This stronger evaporative cooling effect may be used to level temperature, resulting in more uniform mechanical properties and reduced thermal bleed. The increased amount of fusing agent may also add robustness to pen health (e.g., to prevent clogging, for example, through extra use as well as resilience to clogged nozzles), and an increased opportunity to include material property enhancers.

According to examples, for the apparatus and method disclosed herein, by using empirical and thermal models, a fusing agent flux amount determination module may generate a fluid flux map of fluid flux needed per unit area of an object to be produced by a three dimensional printing system to produce relatively constant build temperatures. The fluid flux map may also include thermal information from previous layers and surrounding parts of the object to be produced. The fluid flux map may be integrated into the pre-processing machine readable instructions for a three-dimensional printing module to convert solid geometry of a three-dimensional object to printer instructions. In this regard, the three-dimensional printing module may slice a model of the object to be printed into individual layers. The three-dimensional printing module may determine the levels of fusing and/or detailing agent to be applied on the object to be printed based on area sizes and/or shapes. The three-dimensional printing module may determine any other elements needed, such as, for example, the amount of detailing agent to be applied around the profile of the object to be printed. The three-dimensional printing module may combine the various elements into printer command instructions for the three-dimensional printer, and the three-dimensional printer may use these instructions to print part layers of the object uniformly, one at a time.

According to examples, in addition to or instead of oversaturating of the larger printed areas by using the evaporative cooling potential of fluid to cool the larger printed areas, the detailing agent, which is used to provide for the control of temperatures around the boundaries of areas printed by the fusing agent, may also be placed on top of the areas printed by the fusing agent to cool the larger printed areas. Thus, in this regard, the detailing agent may serve the dual purposes of providing for the control of temperatures around the boundaries of areas printed by the fusing agent, and further, for the cooling of the larger printed areas when the detailing agent is placed on top of the areas printed by the fusing agent.

The apparatus and method disclosed herein may provide for greater control over the leveling of layer temperatures, additional opportunities to apply material property enhancements in the fusing agent, greater robustness to clogged pen nozzles, greater color uniformity, and greater control of thermal bleed.

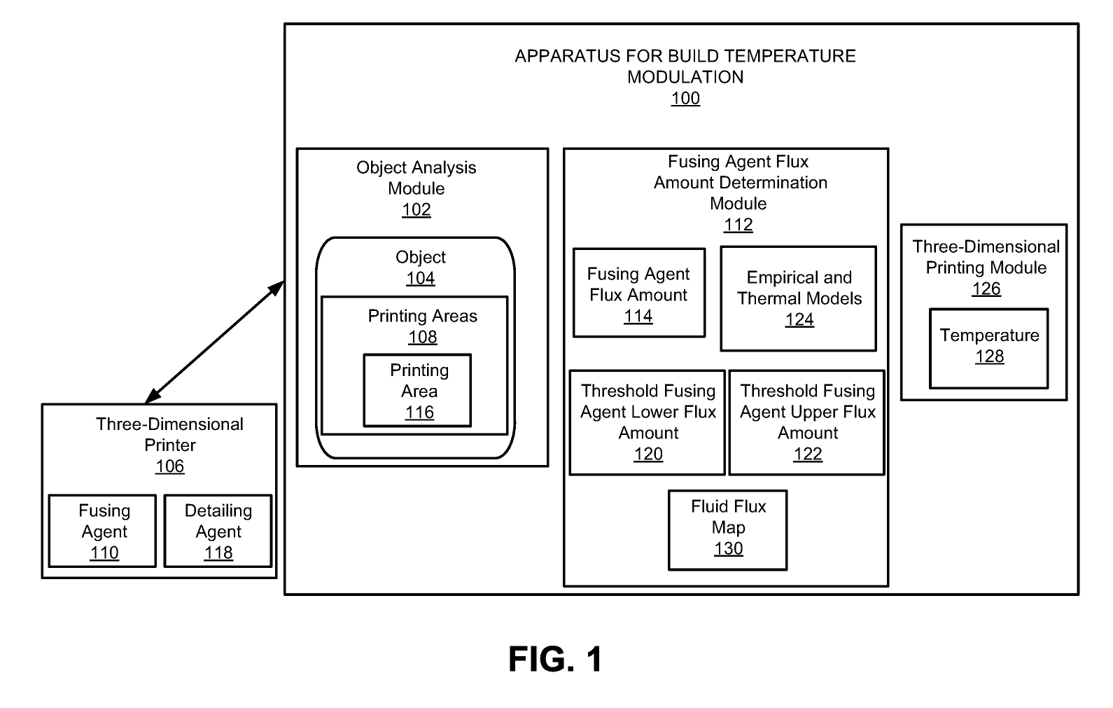

FIG. 1 illustrates an architecture of an apparatus for build temperature modulation (hereinafter also referred to as “apparatus 100”), according to an example of the present disclosure. Referring to FIG. 1, the apparatus 100 is depicted as including an object analysis module 102 to determine a cross-sectional area and/or a cross-sectional shape of an object 104 to be produced by three-dimensional printing, for example, by using a three-dimensional printer 106. The three-dimensional printing system may divide the object 104 into a plurality of printing areas 108 for producing the object 104 by using a fusing agent 110.

A fusing agent flux amount determination module 112 may determine, based on the cross-sectional area and/or the cross-sectional shape of the object 104 to be produced by the three-dimensional printing system, a fusing agent flux amount 114 of the fusing agent 110 sufficient to oversaturate a printing area 116 of the plurality of printing areas 108, for example, by an amount that uses evaporative cooling of the fusing agent 110, to cool the printing area 116 of the plurality of printing areas 108. The fusing agent flux amount 114 may be generally described as a fusing agent flux amount that is greater than a baseline fusing agent flux amount (needed for the printing area 116) by a flux amount sufficient to oversaturate the printing area 116. Further, the fusing agent flux amount may be generally described as a rate of the fusing agent 110 application and/or a quantity of the fusing agent 110 that is applied to the printing area 116. The fusing agent flux amount 114 of the fusing agent 110 may also be sufficient to obtain a specified optical density of the printing area 116, and modulate temperatures related to the plurality of printing areas 108 to a substantially constant temperature across the plurality of printing areas 108. The substantially constant temperature across the plurality of printing areas 108 may include temperatures that fall within a predetermined range (e.g., ±1° C.), or within a user-defined range. Additionally or alternatively, the fusing agent flux amount determination module 112 may determine, based on the cross-sectional area and/or the cross-sectional shape of the object 104 to be produced by the three-dimensional printing, a fusing agent flux amount 114 of the fusing agent 110, and application of a detailing agent 118 that is to be used with the fusing agent 110. The fusing agent flux amount 114 of the fusing agent 110 and the application of the detailing agent 118 may be sufficient to oversaturate the printing area 116, for example, by an amount that uses evaporative cooling of the fusing agent 110 and the detailing agent 118, to cool the printing area 116, and modulate temperatures related to the plurality of printing areas 108 to a substantially constant temperature across the plurality of printing areas 108.

The fusing agent flux amount determination module 112 may determine a relative size of the printing area 116 compared to other printing areas of the plurality of printing areas 108. The fusing agent flux amount determination module 112 may further determine, based on the relative size, a higher fusing agent flux amount of the fusing agent 110 for the printing area 116 that includes a larger cross-sectional area compared to a printing area of the plurality of printing areas 108 that includes a relatively smaller cross-sectional area. The higher fusing agent flux amount may be greater than a baseline fusing agent flux amount (e.g., a fusing agent flux amount that does not account for the evaporative cooling of the fusing agent 110) for the printing area of the plurality of printing areas 108 that includes the larger cross-sectional area.

The fusing agent flux amount determination module 112 may determine the threshold fusing agent lower flux amount 120 related to the fusing agent flux amount 114. The threshold fusing agent lower flux amount 120 may represent a minimum fusing agent flux amount that is to be used to begin the evaporative cooling of the fusing agent 110 to cool the printing area of the plurality of printing areas 108, and modulate the temperatures related to the plurality of printing areas 108 to the substantially constant temperature across the plurality of printing areas 108.

The fusing agent flux amount determination module 112 may determine a threshold fusing agent upper flux amount 122 related to the fusing agent flux amount 114. The threshold fusing agent upper flux amount 122 may represent a maximum fusing agent flux amount that is to be used for the evaporative cooling of the fusing agent 110 to cool the printing area of the plurality of printing areas 108, and modulate the temperatures related to the plurality of printing areas 108 to the substantially constant temperature across the plurality of printing areas 108.

According to an example, the fusing agent flux amount 114 may be greater than the threshold fusing agent lower flux amount 120 and less than the threshold fusing agent upper flux amount 122. The fusing agent flux amount 114 may represent a recommended fusing agent flux amount sufficient to oversaturate the printing area 116 by the amount that uses the evaporative cooling of the fusing agent 110 to cool the printing area of the plurality of printing areas 108, and modulate the temperatures related to the plurality of printing areas 108 to the substantially constant temperature across the plurality of printing areas 108.

According to an example, the fusing agent flux amount determination module 112 may use empirical and thermal models 124 related to the cross-sectional area and/or the cross-sectional shape of the object 104 to be produced by the three-dimensional printing to determine the fusing agent flux amount 114.

A three-dimensional printing module 126 may determine a temperature 128 associated with production of the object 104 without use of the fusing agent flux amount 114 of the fusing agent 110 sufficient to oversaturate the printing area 116. Further, the three-dimensional printing module 126 may increase the temperature 128 associated with the production of the object 104 based on the use of the fusing agent flux amount 114 of the fusing agent 110 sufficient to oversaturate the printing area 116.

The modules and other elements of the apparatus 100 may be machine readable instructions stored on a non-transitory computer readable medium. In this regard, the apparatus 100 may include or be a non-transitory computer readable medium. In addition, or alternatively, the modules and other elements of the apparatus 100 may be hardware or a combination of machine readable instructions and hardware.

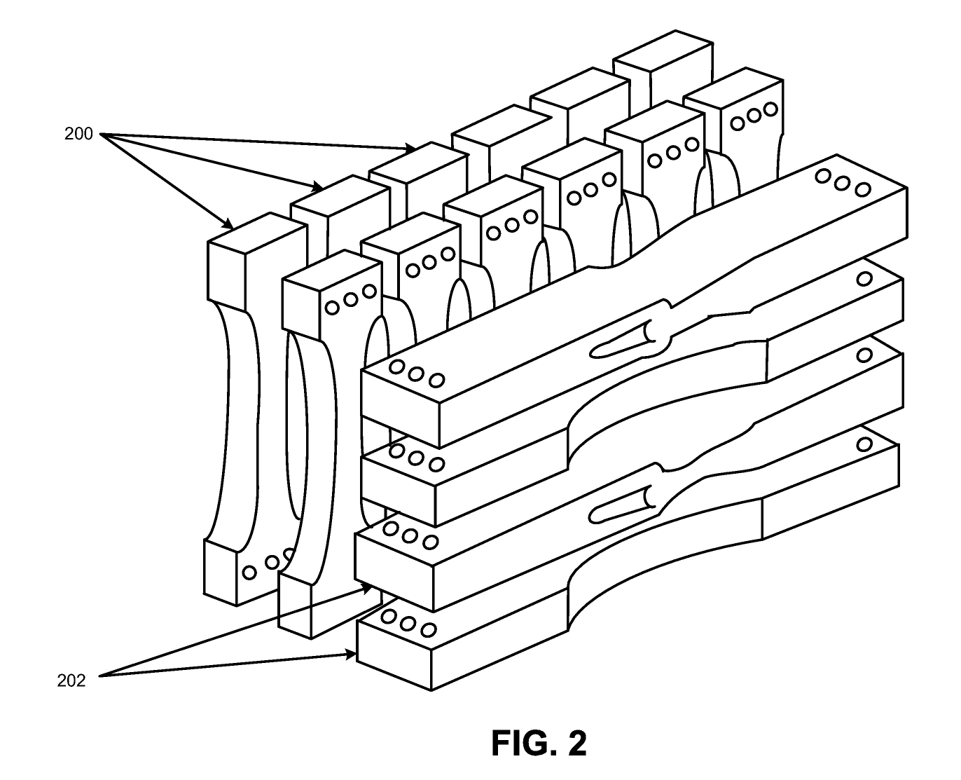

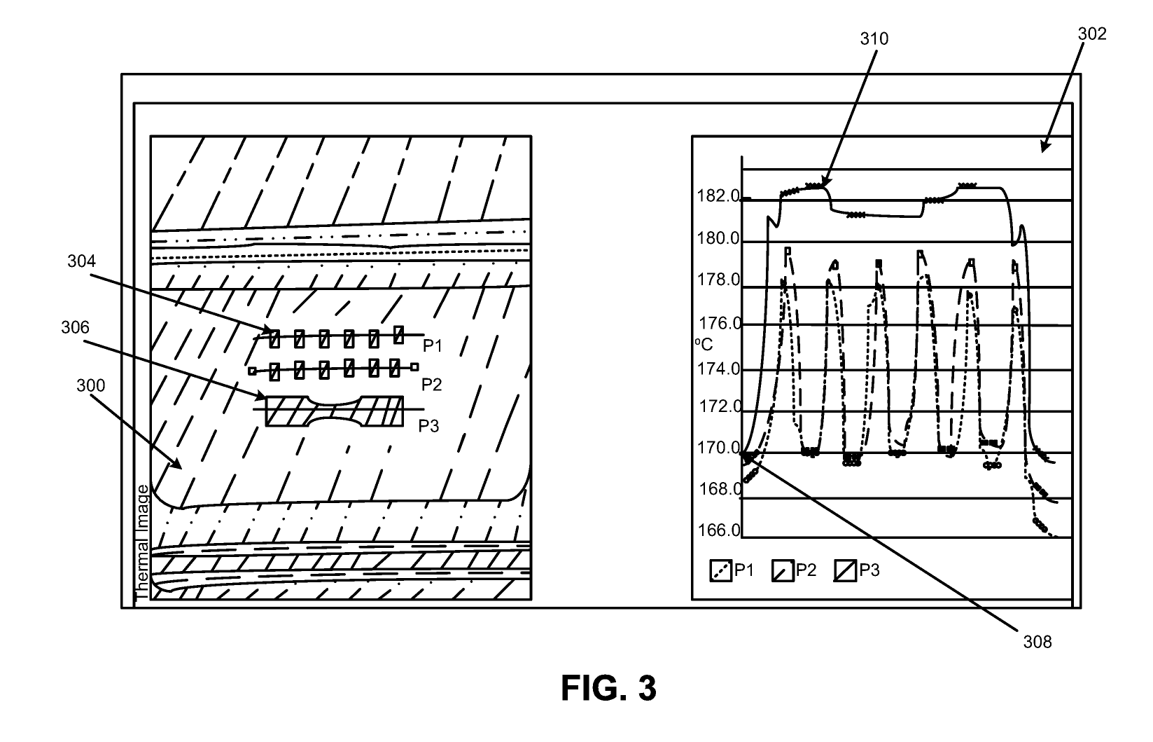

FIG. 2 illustrates three-dimensional objects disposed in vertical and horizontal orientations, according to an example of the present disclosure. FIG. 3 illustrates an image of a thermal slice of the objects of FIG. 2, and a graph of related temperature variation, according to an example of the present disclosure.

Referring to FIG. 2, with respect to the three-dimensional objects 200 disposed in a vertical orientation and the three-dimensional objects 202 disposed in a horizontal orientation, FIG. 3 represents an image of a thermal slice of the objects 200 and 202, and a graph of related temperature variation of the objects 200 and 202 (i.e., across the thermal slice of the objects 200 and 202). The objects 200 and 202 may represent a single object 104, or a plurality of objects 104 that are used as part of a larger component. For FIG. 3, the area 300 may represent un-solidified powder (e.g., white nylon powder). In order to produce the objects 200 and 202, certain areas of the un-solidified powder may be printed. The printed areas may be irradiated, for example, with fusing lamps, and based on the proper application of irradiation, the printed areas effectively melt before the surrounding un-solidified powder. For FIGS. 3, P1, P2, and P3 may represent lines through which the empirical thermal data is measured and illustrated at 302. As shown in FIG. 3, the relatively smaller geometry at 304 (i.e., the relatively smaller cross-sectional area) of the three-dimensional objects 200 produces colder peaks (e.g., the peaks for P1 and P2) compared to the relatively larger geometry at 306 (i.e., the relatively larger cross-sectional area) of the three-dimensional objects 202 (e.g., the corresponding temperature for P3). The relatively colder peaks (e.g., the peaks for P1 and P2) for the three-dimensional objects 200 may reduce the tensile strength of the three-dimensional objects 200 compared to the three-dimensional objects 202.

In order to adjust the printing process parameters to eliminate the colder peaks (e.g., the peaks for P1 and P2) for the three-dimensional objects 200 compared to the relatively larger geometry at 306 of the three-dimensional objects 202 (e.g., the corresponding temperature for P3), the flux of the fusing agent 110 used to produce the three-dimensional objects 200 and 202 may be adjusted by the fusing agent flux amount determination module 112.

With respect to adjustment of the flux of the fusing agent 110 by the fusing agent flux amount determination module 112, the fusing agent flux amount determination module 112 may vary a contone level (i.e., vary the density of the fusing agent 110) to stabilize the temperatures of various objects (e.g., the three-dimensional objects 200 and 202) that are being produced. In order to stabilize the temperatures of various objects that are being produced, the fusing agent flux amount determination module 112 may increase the flux amount of the fusing agent 110 for the larger objects, such as the three-dimensional objects 202, to increase the evaporative cooling effect of the fusing agent 110. That is, until a threshold fusing agent lower flux amount 120 of fusing agent flux of the fusing agent 110, the fusing agent 110 may absorb more energy from the fusing lamps to generate more heat. However, beyond the threshold fusing agent lower flux amount 120 of fusing agent flux of the fusing agent 110, the increased flux amount (and thus the increased resulting amount) of the fusing agent 110 may increase the evaporative cooling effect more than any change in absorptivity related to the fusing agent 110. The evaporative cooling effect may be based on the wetness of excessive fusing agent due to the increased flux amount of the fusing agent 110. The evaporative cooling effect may lower the temperature of the relatively larger geometry at 306 of the three-dimensional objects 202 (e.g., the corresponding temperature for P3) to thus eliminate the relatively colder peaks (e.g., the peaks for P1 and P2) for the three-dimensional objects 200 compared to the relatively larger geometry at 306 of the three-dimensional objects 202 (e.g., the corresponding temperature for P3).

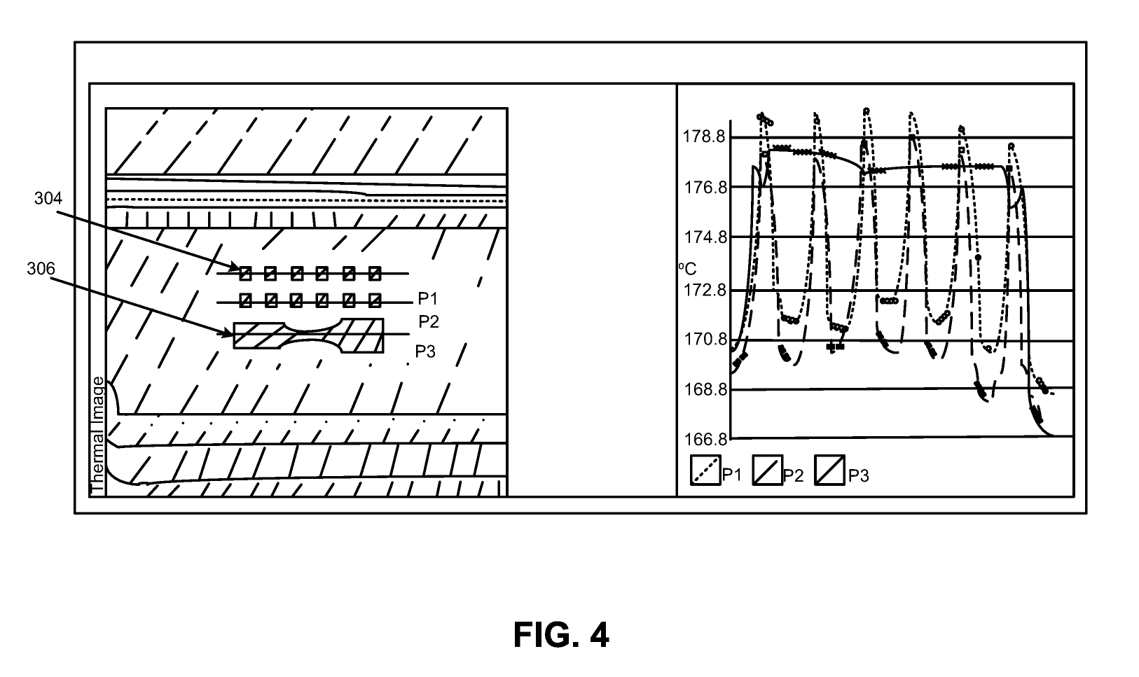

As shown in FIG. 4, based on the increased flux amount of the fusing agent 110 with respect to the relatively larger geometry at 306, the relatively smaller geometry at 304 of the three-dimensional objects 200 may produce similar peaks (e.g., the peaks for P1 and P2) compared to the relatively larger geometry at 306 of the three-dimensional objects 202 (e.g., the corresponding temperature for P3). Further, the increased flux amount of the fusing agent 110 with respect to the relatively larger geometry at 306, which cools the relatively larger geometry at 306, may also allow using overall hotter conditions (e.g., temperatures) to then melt the relatively smaller geometry at 304 equally as well as the relatively larger geometry at 306.

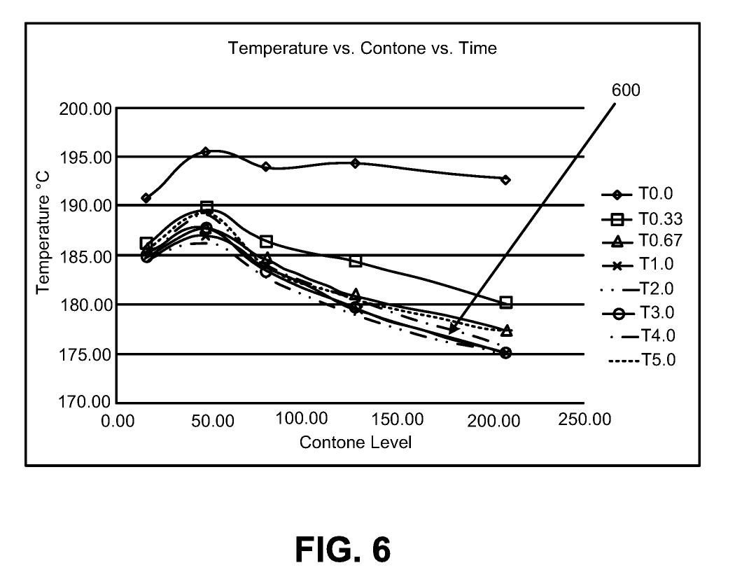

In order to determine the threshold fusing agent lower flux amount 120 of fusing agent flux, with respect to increasing the fluid flux over larger areas, beyond a certain point (e.g., the threshold fusing agent lower flux amount 120 of fusing agent flux), adding more fusing agent may increase the evaporative cooling effect more than any change in absorptivity. In this regard, the fusing agent flux amount determination module 112 may utilize asymptotic curves such as the curve P3 for FIG. 3, and similarly, the asymptotic curves for FIG. 6 as described herein. Referring to the curve P3 for FIG. 3, it can be seen that at 308 when no fusing agent 110 is applied for the larger geometry at 306, the temperature is approximately 170° F. However, as additional fusing agent 110 is applied for the larger geometry at 306, at 310, curve P3 displays a generally asymptotic behavior with the temperature of approximately 182° F. Thus, any additional fusing agent 110 does not increase the temperature beyond the generally peak temperature of approximately 182° F. Thus, the fusing agent flux amount determination module 112 may identify (or approximate) the point at which the curve P3 displays a generally asymptotic behavior with the temperature of approximately 182° F., and designate the identified point as the threshold fusing agent lower flux amount 120. Based on a total flux that ranges from no flux (i.e., 0% flux) to a maximum flux (i.e., 100% flux), the fusing agent flux amount determination module 112 may determine the threshold fusing agent lower flux amount 120 as a percentage of the maximum flux (e.g., as a threshold fusing agent lower flux percentage).

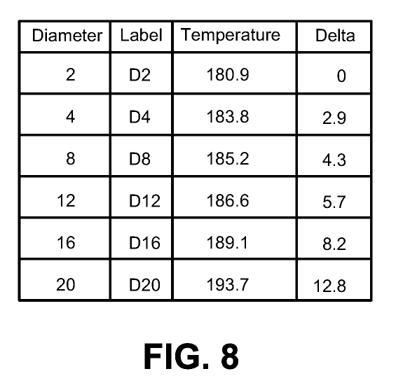

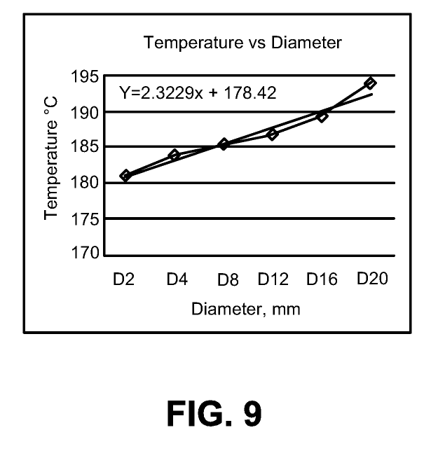

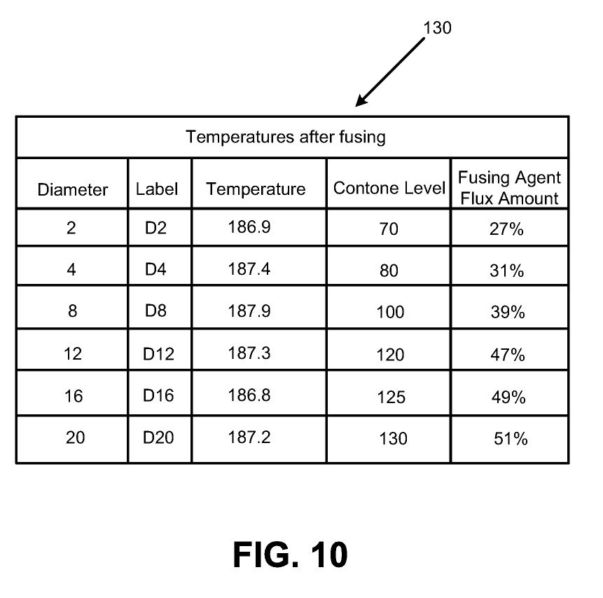

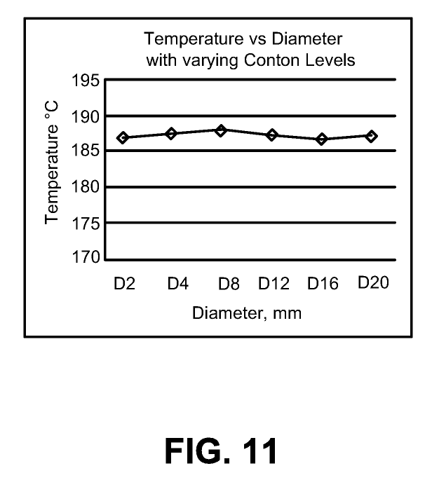

The fusing agent flux amount determination module 112 may also determine the fusing agent flux amount 114 based on a first graph (i.e., an empirical model (e.g., FIGS. 8 and 9 as described herein)) of thermal energy retained with respect to a constant amount of the fusing agent 110 and varying geometry of the object 104, and a second graph (i.e., a thermal model (e.g., FIG. 6 as described herein)) of evaporative cooling related to the addition of the fusing agent 110 (i.e., the addition of the fusing agent 110 will generally increase evaporative cooling). Based on these two graphs (and/or data related to the absorptivity with respect to a constant amount of the fusing agent 110 and varying geometry of the object 104, and evaporative cooling related to the addition of the fusing agent 110), the fusing agent flux amount 114 may be determined such that a sufficient amount of the fusing agent 110 is applied to obtain a needed optical density, and to properly modulate the temperature of the components being produced based on the evaporative cooling (e.g., FIGS. 10 and 11 as described herein). The fusing agent flux amount 114 may represent a recommended fusing agent flux amount.

With respect to the fusing agent flux amount 114, by using the empirical and thermal models, the fusing agent flux amount determination module 112 may generate a fluid flux map 130 (e.g., FIG. 10 as described herein) of fluid flux needed per unit area (e.g., the fusing agent flux amount 114) to produce relatively constant build temperatures. As described herein, the empirical models may represent, for example, the first graph of absorptivity with respect to a constant amount of the fusing agent 110 and varying geometry of the object 104. As described herein, the thermal models may represent, for example, and the second graph of evaporative cooling related to the addition of the fusing agent 110. For example, as shown in FIG. 10, the fluid flux map 130 may generally include a chart of areas of cross-sections (e.g., column of diameters) that are to be produced for the object 104, and corresponding fusing agent flux amounts 114. The areas of cross-sections may also be separated based on types (i.e., shapes) of cross-sections. For example, a square cross-section may include different thermal properties compared to a hexagonal or triangular cross-section. The fluid flux map 130 may also include thermal information from previous layers and surrounding parts. The fluid flux map 130 may be integrated into the pre-processing machine readable instructions for the three-dimensional printing module 126 to convert solid geometry of a three-dimensional object to printer instructions.

With respect to FIG. 10, the fluid flux map 130 may be applied with an image pipeline that may apply the threshold fusing agent lower flux amount 120 on an outer shell of the object 104 (e.g., outer 1 mm shell), another threshold fusing agent lower flux amount 120 on the next inner shell of the object 104 (e.g., the next 1 mm shell), and an increasing threshold fusing agent lower flux amount 120 until the maximum (e.g., threshold fusing agent upper flux amount 122) is reached. This variation in the threshold fusing agent lower flux amount 120 based on the particular shell layer of an object may account for virtually any shape of the object 104. For example, a 2 mm outer diameter cylinder may include one 1 mm shell. However, a 6 mm outer diameter cylinder may include three 1 mm shells, and be printed at three contone levels. In this regard, the fusing agent flux amount determination module 112 may make continuous variations in the threshold fusing agent lower flux amount 120.

With respect to converting the solid geometry of a three-dimensional object to printer instructions, the three-dimensional printing module 126 may slice a solid model of the object 104 to be printed into individual layers. The three-dimensional printing module 126 may determine the levels of the fusing agent 110 and/or the detailing agent 118 to be applied on the object 104 to be printed based on parameters, such as, area sizes, shapes, etc. The three-dimensional printing module 126 may determine any other elements needed, such as, for example, the amount of the detailing agent 118 to be applied around the profile of the object 104 to be printed. The three-dimensional printing module 126 may combine the various elements into printer command instructions for the three-dimensional printer 106, and the three-dimensional printer 106 may use these instructions to print layers of the object 104 uniformly, one at a time.

As described herein, the apparatus 100 may generally provide for the oversaturating of the larger printed areas to cool the larger printed areas such that overall hotter conditions may be used to melt smaller printed areas equally as well as the larger printed areas. In this regard, referring to FIGS. 3 and 4, since the oversaturating of the larger printed areas (e.g., the relatively larger geometry at 306) is used to cool the larger printed areas, the decrease in the temperatures related to the larger printed areas may interfere with the overall curing of the larger printed areas. In this regard, overall hotter conditions (e.g., temperatures) may be used to melt smaller printed areas (e.g., the relatively smaller geometry at 304) equally as well as the larger printed areas. For example, once the larger printed areas are oversaturated, the overall temperature related to the larger and smaller printed areas may be increased to melt the smaller printed areas equally as well as the larger printed areas. The overall increase in temperature related to the larger and smaller printed areas may provide for adequate curing of the larger and smaller printed areas.

The fusing agent flux amount determination module 112 may further determine the threshold fusing agent upper flux amount 122 of fusing agent flux which may represent a maximum amount of increased flux. The threshold fusing agent upper flux amount 122 of fusing agent flux may be related to the threshold fusing agent lower flux amount 120 of fusing agent flux as follows (threshold fusing agent lower flux amount 120<fusing agent flux amount 114<threshold fusing agent upper flux amount 122). The threshold fusing agent upper flux amount 122 of fusing agent flux may be determined to maintain the needed material properties of the object 104 that is being printed. The threshold fusing agent upper flux amount 122 of fusing agent flux may also be limited by the amount of printing fluid that can physically be printed at speed and/or by a relatively small delta needed between printing small and large parts of the object 104.

According to examples, in addition to or instead of oversaturating of the larger printed areas (e.g., the relatively larger geometry at 306) to use the evaporative cooling potential of fluid (e.g., the fusing agent 110) to cool the larger printed areas, the detailing agent 118, which is used to provide for the control of temperatures around the boundaries of areas printed by the fusing agent 110, may also be placed on top of the areas printed by the fusing agent 110 to cool the larger printed areas. Thus, in this regard, the detailing agent 118 may serve the dual purposes of providing for the control of temperatures around the boundaries of areas printed by the fusing agent 110, and further for the cooling of the larger printed areas when the detailing agent is placed on top of the areas printed by the fusing agent. Further, if the detailing agent 118 is used for the cooling of the larger printed areas when the detailing agent is placed on top of the areas printed by the fusing agent, a corresponding fusing agent flux amount 114 may be reduced to account for the cooling provided by the detailing agent 118. This option may be applied if, for example, the physical limits of printing fluid are reached on the fusing agent pens.

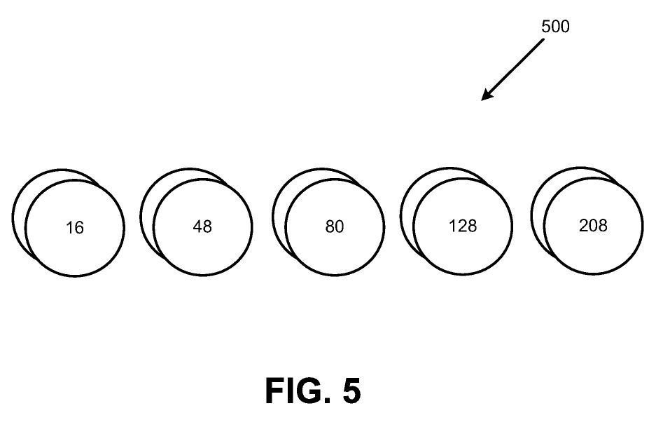

FIG. 5 illustrates three-dimensional objects of the same diameter, but printed at varying contone levels, according to an example of the present disclosure.

Referring to FIG. 5, with respect to the three-dimensional objects 500, FIG. 6 illustrates a graph of temperature versus contone level, according to an example of the present disclosure. Referring to FIG. 6, the graph of temperature versus contone level may represent data taken at a predetermined layer of each of the three-dimensional objects 500, at contone levels of 16, 48, 80, 128, and 208, (i.e., fusing agent flux amount 114 of 6%, 19%, 31%, 50%, and 81%). For the example of FIG. 6, with respect to measurement 600, the generally steady slope may be determined as (172−188)/(208−48)=−0.1° C./Contone level unit. Thus, referring to FIG. 6, for maximum strength, the relatively smallest parts may be printed at contone level 50 (i.e., fusing agent flux amount 114 of 20%), and the relatively larger parts may be cooled with increasing contone levels.

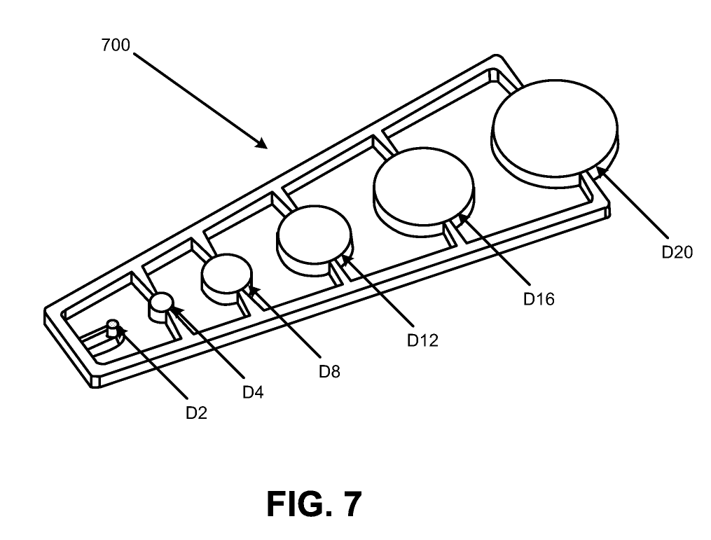

FIG. 7 illustrates three-dimensional objects 700 of different diameters, according to an example of the present disclosure.

FIG. 8 illustrates a table of temperature versus diameter for the three-dimensional objects of FIG. 7, when printed at a constant contone level, for example, of 80 (i.e., fusing agent flux amount 114 of 31%), and corresponding temperature delta, according to an example of the present disclosure. The temperature delta may represent a change in temperature between different diameters (e.g., D4 vs. D2, etc.). The minimum threshold fusing agent lower flux amount 120 may be applied to the relatively smallest feature, for example a 2 mm diameter part. The delta temperatures may be used to estimate the increase in contone levels needed.

Referring to FIG. 8, the table of temperature versus diameter for the three-dimensional objects of FIG. 7, and corresponding temperature delta versus contone level may be determined for a fixed contone level (e.g., a contone level of 80 (i.e., fusing agent flux amount 114 of 31%)). Further, FIG. 9 illustrates a graph of temperature versus diameter for the three-dimensional objects of FIG. 7, according to an example of the present disclosure. For the example of FIGS. 8 and 9, a line y=2.3229x+178.42 may be used to represent the temperature and diameter values, where y represents temperature, and x represents diameter (representing approximately 2.32° C./dia-mm for the example of FIG. 8).

FIG. 10 illustrates a table of temperature versus diameter for the three-dimensional objects of FIG. 7, for varying contone levels, according to an example of the present disclosure. Further, FIG. 11 illustrates a graph of temperature versus diameter for the three-dimensional objects of FIG. 7, for varying contone levels, according to an example of the present disclosure.

Referring to FIGS. 10 and 11, the information from FIGS. 5-9 may be used to determine the fluid flux map 130 of fluid flux needed per unit area (e.g., the fusing agent flux amount 114) to produce relatively constant build temperatures. For the example of FIGS. 10 and 11, an increasing fusing agent flux amount 114 from 27% (i.e., contone level 70, and diameter D2) to a fusing agent flux amount 114 of 51% (i.e., contone level 130, and diameter D20) may be used to produce relatively constant build temperatures as shown in FIG. 11, regardless of the variations in the geometry of the three-dimensional objects 700.

As disclosed herein, the empirical and thermal models 124 may be related to the cross-sectional area and/or the cross-sectional shape of the object 104 to be produced by the three-dimensional printing to determine the fusing agent flux amount 114. Thus, for the example of FIGS. 5-11, the types (i.e., shapes) of cross-sections may also be taken into account for the object 104 to be produced by the three-dimensional printing to determine the fusing agent flux amount 114. With respect to FIGS. 5-11, a different fusing agent flux amount 114 may be specified for the circular three-dimensional objects 700, versus objects of different shapes. As described herein with reference to FIG. 10, a shell approach may be used to accommodate any shape of the object 104.

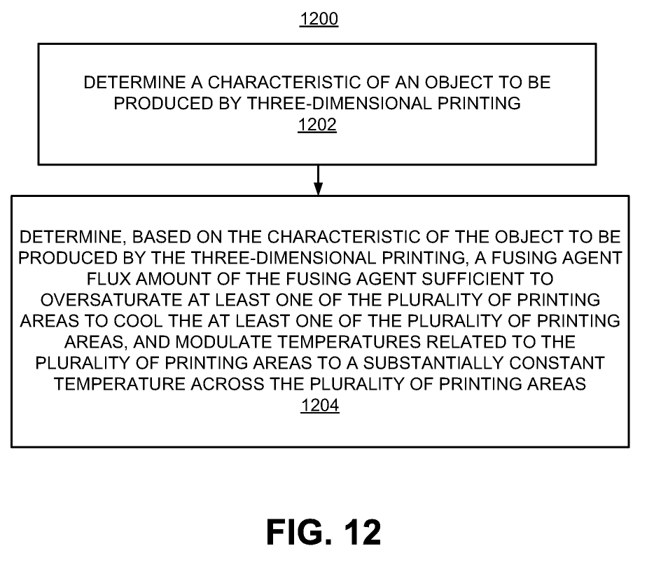

FIGS. 12-14 respectively illustrate flowcharts of methods 1200, 1300, and 1400 for build temperature modulation, corresponding to the example of the apparatus 100 whose construction is described in detail above. The methods 1200, 1300, and 1400 may be implemented on the apparatus 100 with reference to FIGS. 1-11 by way of example and not limitation. The methods 1200, 1300, and 1400 may be practiced in other apparatus.

Referring to FIGS. 1 and 12, for the method 1200, at block 1202, the method may include determining a characteristic (e.g., a cross-sectional area and/or a cross-sectional shape) of an object 104 to be produced by three-dimensional printing. The three-dimensional printing may divide the object 104 into a plurality of printing areas 108 for producing the object 104 by using a fusing agent 110.

At block 1204, the method may include determining, based on the characteristic of the object 104 to be produced by the three-dimensional printing, a fusing agent flux amount 114 of the fusing agent 110 sufficient to oversaturate at least one of the plurality of printing areas 108, for example, by an amount that uses evaporative cooling of the fusing agent 110, to cool the at least one of the plurality of printing areas 108, and modulate temperatures related to the plurality of printing areas 108 to a substantially constant temperature across the plurality of printing areas 108. The fusing agent flux amount may be generally described as a rate of the fusing agent 110 application and/or a quantity of the fusing agent 110 that is applied to the at least one of the plurality of printing areas 108. Further, the substantially constant temperature across the plurality of printing areas 108 may include temperatures that fall within a predetermined range (e.g., ±2° F.).

According to an example, the method 1200 may further include causing application of the determined fusing agent flux amount 114 of the fusing agent 110 on the at least one of the plurality of printing areas 108.

According to an example, determining, based on the characteristic of the object 104 to be produced by the three-dimensional printing, the fusing agent flux amount 114 of the fusing agent 110 sufficient to oversaturate the at least one of the plurality of printing areas 108 to cool the at least one of the plurality of printing areas 108, and modulate the temperatures related to the plurality of printing areas 108 to the substantially constant temperature across the plurality of printing areas 108 may further include determining a relative size of the at least one of the plurality of printing areas 108 compared to other printing areas of the plurality of printing areas 108, and determining, based on the relative size, a higher fusing agent flux amount 114 of the fusing agent 110 for the at least one of the plurality of printing areas 108 that includes a larger cross-sectional area compared to a printing area of the plurality of printing areas 108 that includes a relatively smaller cross-sectional area. The higher fusing agent flux amount may be greater than a baseline fusing agent flux amount (e.g., a fusing agent flux amount that does not account for the evaporative cooling of the fusing agent 110) for the at least one of the plurality of printing areas 108 that includes the larger cross-sectional area.

According to an example, determining, based on the characteristic of the object 104 to be produced by the three-dimensional printing, the fusing agent flux amount 114 of the fusing agent 110 sufficient to oversaturate the at least one of the plurality of printing areas 108 to cool the at least one of the plurality of printing areas 108, and modulate the temperatures related to the plurality of printing areas 108 to the substantially constant temperature across the plurality of printing areas 108 may further include determining a threshold fusing agent lower flux amount 120 related to the fusing agent flux amount 114. The threshold fusing agent lower flux amount 120 may represent a minimum fusing agent flux amount that is to be used to begin the evaporative cooling of the fusing agent 110 to cool the at least one of the plurality of printing areas 108, and modulate the temperatures related to the plurality of printing areas 108 to the substantially constant temperature across the plurality of printing areas 108.

According to an example, determining, based on the characteristic of the object 104 to be produced by the three-dimensional printing, the fusing agent flux amount 114 of the fusing agent 110 sufficient to oversaturate the at least one of the plurality of printing areas 108 to cool the at least one of the plurality of printing areas 108, and modulate the temperatures related to the plurality of printing areas 108 to the substantially constant temperature across the plurality of printing areas 108 may further include determining a threshold fusing agent upper flux amount 122 related to the fusing agent flux amount 114. The threshold fusing agent upper flux amount 122 may represent a maximum fusing agent flux amount that is to be used for the evaporative cooling of the fusing agent 110 to cool the at least one of the plurality of printing areas 108, and modulate the temperatures related to the plurality of printing areas 108 to the substantially constant temperature across the plurality of printing areas 108.

According to an example, determining, based on the characteristic of the object 104 to be produced by the three-dimensional printing, the fusing agent flux amount 114 of the fusing agent 110 sufficient to oversaturate the at least one of the plurality of printing areas 108 to cool the at least one of the plurality of printing areas 108, and modulate the temperatures related to the plurality of printing areas 108 to the substantially constant temperature across the plurality of printing areas 108 may further include determining a threshold fusing agent lower flux amount 120 related to the fusing agent flux amount 114, where the threshold fusing agent lower flux amount 120 may represent a minimum fusing agent flux amount that is to be used to begin evaporative cooling of the fusing agent 110 to cool the at least one of the plurality of printing areas 108, and modulate the temperatures related to the plurality of printing areas 108 to the substantially constant temperature across the plurality of printing areas 108, and determining a threshold fusing agent upper flux amount 122 related to the fusing agent flux amount 114, where the threshold fusing agent upper flux amount 122 may represent a maximum fusing agent flux amount that is to be used for the evaporative cooling of the fusing agent 110 to cool the at least one of the plurality of printing areas 108, and modulate the temperatures related to the plurality of printing areas 108 to the substantially constant temperature across the plurality of printing areas 108. The fusing agent flux amount 114 may be greater than the threshold fusing agent lower flux amount 120 and less than the threshold fusing agent upper flux amount 122. Further, the fusing agent flux amount 114 may represent a recommended fusing agent flux amount 114 sufficient to oversaturate the at least one of the plurality of printing areas 108 to cool the at least one of the plurality of printing areas 108, and modulate the temperatures related to the plurality of printing areas 108 to the substantially constant temperature across the plurality of printing areas 108.

According to an example, determining, based on the characteristic of the object 104 to be produced by the three-dimensional printing, the fusing agent flux amount 114 of the fusing agent 110 sufficient to oversaturate the at least one of the plurality of printing areas 108 to cool the at least one of the plurality of printing areas 108, and modulate the temperatures related to the plurality of printing areas 108 to the substantially constant temperature across the plurality of printing areas 108 may further include the using empirical and thermal models 124 related to the characteristic of the object 104 to be produced by the three-dimensional printing to determine the fusing agent flux amount 114.

According to an example, the method 1200 may further include determining a temperature associated with production of the object 104 without use of the fusing agent flux amount 114 of the fusing agent 110 sufficient to oversaturate the at least one of the plurality of printing areas 108, and increasing the temperature associated with the production of the object 104 to the substantially constant temperature based on the use of the fusing agent flux amount 114 of the fusing agent 110 sufficient to oversaturate the at least one of the plurality of printing areas 108.

According to an example, determining, based on the characteristic of the object 104 to be produced by the three-dimensional printing, the fusing agent flux amount 114 of the fusing agent 110 sufficient to oversaturate the at least one of the plurality of printing areas 108 to cool the at least one of the plurality of printing areas 108, and modulate the temperatures related to the plurality of printing areas 108 to the substantially constant temperature across the plurality of printing areas 108 may further include determining the fusing agent flux amount 114 of the fusing agent 110 sufficient to obtain a specified optical density of the at least one of the plurality of printing areas 108.

According to an example, determining, based on the characteristic of the object 104 to be produced by the three-dimensional printing, the fusing agent flux amount 114 of the fusing agent 110 sufficient to oversaturate the at least one of the plurality of printing areas 108 to cool the at least one of the plurality of printing areas 108, and modulate the temperatures related to the plurality of printing areas 108 to the substantially constant temperature across the plurality of printing areas 108 may further include dividing the object 104 to be produced into a plurality of shells including predetermined diameters, where each shell of the plurality of shells includes a predetermined thickness, and for each shell of the plurality of shells, determining a different fusing agent flux amount of the fusing agent110.

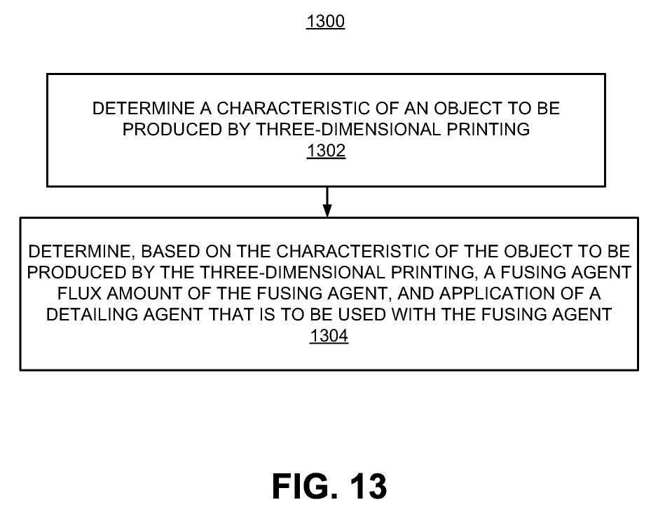

Referring to FIGS. 1 and 13, for the method 1300, at block 1302, the method may include determining a characteristic of an object 104 to be produced by three-dimensional printing. The three-dimensional printing may divide the object 104 into a plurality of printing areas 108 for producing the object 104 by using a fusing agent 110.

At block 1304, the method may include determining, based on the characteristic of the object 104 to be produced by the three-dimensional printing, a fusing agent flux amount 114 of the fusing agent 110, and application of a detailing agent 118 that is to be used with the fusing agent 110. The fusing agent flux amount 114 of the fusing agent 110 and the application of the detailing agent 118 may be sufficient to oversaturate at least one of the plurality of printing areas 108, for example, by an amount that uses evaporative cooling of the fusing agent 110 and the detailing agent 118, to cool the at least one of the plurality of printing areas 108, and modulate temperatures related to the plurality of printing areas 108 to a substantially constant temperature across the plurality of printing areas 108.

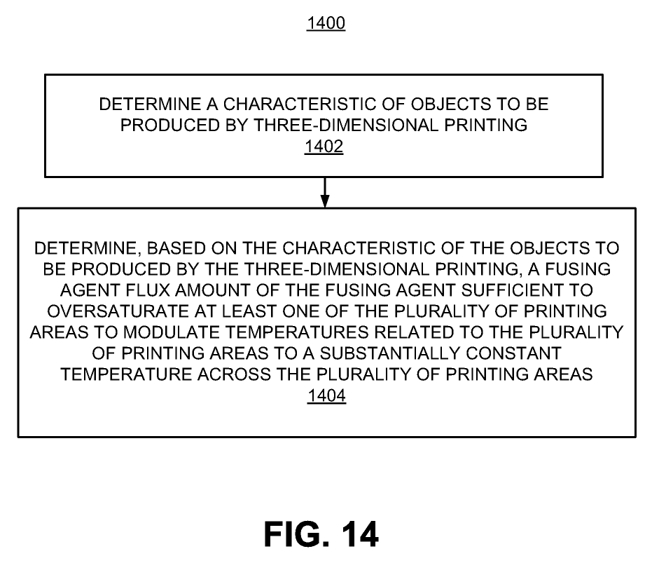

Referring to FIGS. 1 and 14, for the method 1400, at block 1402, the method may include determining a characteristic of objects 104 to be produced by three-dimensional printing. The three-dimensional printing may divide the objects 104 into a plurality of printing areas 108 for producing the objects 104 by using a fusing agent 110.

At block 1404, the method may include determining, based on the characteristic of the objects 104 to be produced by the three-dimensional printing, a fusing agent flux amount 114 of the fusing agent 110 sufficient to oversaturate at least one of the plurality of printing areas 108 to modulate temperatures related to the plurality of printing areas 108 to a substantially constant temperature across the plurality of printing areas 108.

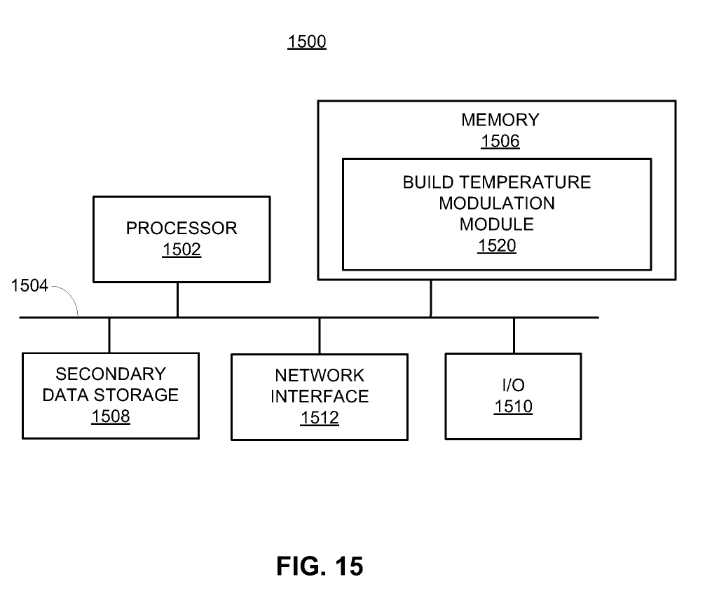

FIG. 15 shows a computer system 1500 that may be used with the examples described herein. The computer system 1500 may represent a generic platform that includes components that may be in a server or another computer system. The computer system 1500 may be used as a platform for the apparatus 100. The computer system 1500 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory).

The computer system 1500 may include a processor 1502 that may implement or execute machine readable instructions performing some or all of the methods, functions and other processes described herein. Commands and data from the processor 1502 may be communicated over a communication bus 1504. The computer system may also include a main memory 1506, such as a random access memory (RAM), where the machine readable instructions and data for the processor 1502 may reside during runtime, and a secondary data storage 1508, which may be non-volatile and stores machine readable instructions and data. The memory and data storage are examples of computer readable mediums. The memory 1506 may include a build temperature modulation module 1520 including machine readable instructions residing in the memory 1506 during runtime and executed by the processor 1502. The build temperature modulation module 1520 may include the modules of the apparatus 100 shown in FIG. 1.

The computer system 1500 may include an I/O device 1510, such as a keyboard, a mouse, a display, etc. The computer system may include a network interface 1512 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for build temperature modulation, the method comprising:
determining a characteristic of an object to be produced by three-dimensional printing, wherein the three-dimensional printing divides the object into a plurality of printing areas for producing the object by using a fusing agent; and
determining, by a processor, based on the characteristic of the object to be produced by the three-dimensional printing, a fusing agent flux amount of the fusing agent sufficient to oversaturate at least one of the plurality of printing areas to
cool the at least one of the plurality of printing areas, and
modulate temperatures related to the plurality of printing areas to a substantially constant temperature across the plurality of printing areas.

2. The method according to claim 1, further comprising:
causing, by the processor, application of the determined fusing agent flux amount of the fusing agent on the at least one of the plurality of printing areas.

3. The method according to claim 1, wherein determining, based on the characteristic of the object to be produced by the three-dimensional printing, the fusing agent flux amount of the fusing agent sufficient to oversaturate the at least one of the plurality of printing areas to cool the at least one of the plurality of printing areas, and modulate the temperatures related to the plurality of printing areas to the substantially constant temperature across the plurality of printing areas further comprises:
determining a relative size of the at least one of the plurality of printing areas compared to other printing areas of the plurality of printing areas; and
determining, based on the relative size, a higher fusing agent flux amount of the fusing agent for the at least one of the plurality of printing areas that includes a larger cross-sectional area compared to a printing area of the plurality of printing areas that includes a relatively smaller cross-sectional area, wherein the higher fusing agent flux amount is greater than a baseline fusing agent flux amount for the at least one of the plurality of printing areas that includes the larger cross-sectional area.

4. The method according to claim 1, wherein determining, based on the characteristic of the object to be produced by the three-dimensional printing, the fusing agent flux amount of the fusing agent sufficient to oversaturate the at least one of the plurality of printing areas to cool the at least one of the plurality of printing areas, and modulate the temperatures related to the plurality of printing areas to the substantially constant temperature across the plurality of printing areas further comprises:
determining a threshold fusing agent lower flux amount related to the fusing agent flux amount, wherein the threshold fusing agent lower flux amount is a minimum fusing agent flux amount that is to be used to begin evaporative cooling of the fusing agent to cool the at least one of the plurality of printing areas, and modulate the temperatures related to the plurality of printing areas to the substantially constant temperature across the plurality of printing areas.

5. The method according to claim 1, wherein determining, based on the characteristic of the object to be produced by the three-dimensional printing, the fusing agent flux amount of the fusing agent sufficient to oversaturate the at least one of the plurality of printing areas to cool the at least one of the plurality of printing areas, and modulate the temperatures related to the plurality of printing areas to the substantially constant temperature across the plurality of printing areas further comprises:
determining a threshold fusing agent upper flux amount related to the fusing agent flux amount, wherein the threshold fusing agent upper flux amount is a maximum fusing agent flux amount that is to be used for evaporative cooling of the fusing agent to cool the at least one of the plurality of printing areas, and modulate the temperatures related to the plurality of printing areas to the substantially constant temperature across the plurality of printing areas.

6. The method according to claim 1, wherein determining, based on the characteristic of the object to be produced by the three-dimensional printing, the fusing agent flux amount of the fusing agent sufficient to oversaturate the at least one of the plurality of printing areas to cool the at least one of the plurality of printing areas, and modulate the temperatures related to the plurality of printing areas to the substantially constant temperature across the plurality of printing areas further comprises:
determining a threshold fusing agent lower flux amount related to the fusing agent flux amount, wherein the threshold fusing agent lower flux amount is a minimum fusing agent flux amount that is to be used to begin evaporative cooling of the fusing agent to cool the at least one of the plurality of printing areas, and modulate the temperatures related to the plurality of printing areas to the substantially constant temperature across the plurality of printing areas; and
determining a threshold fusing agent upper flux amount related to the fusing agent flux amount, wherein the threshold fusing agent upper flux amount is a maximum fusing agent flux amount that is to be used for the evaporative cooling of the fusing agent to cool the at least one of the plurality of printing areas, and modulate the temperatures related to the plurality of printing areas to the substantially constant temperature across the plurality of printing areas,
wherein the fusing agent flux amount is greater than the threshold fusing agent lower flux amount and less than the threshold fusing agent upper flux amount, and wherein the fusing agent flux amount represents a recommended fusing agent flux amount sufficient to oversaturate the at least one of the plurality of printing areas to cool the at least one of the plurality of printing areas, and modulate the temperatures related to the plurality of printing areas to the substantially constant temperature across the plurality of printing areas.

7. The method according to claim 1, wherein determining, based on the characteristic of the object to be produced by the three-dimensional printing, the fusing agent flux amount of the fusing agent sufficient to oversaturate the at least one of the plurality of printing areas to cool the at least one of the plurality of printing areas, and modulate the temperatures related to the plurality of printing areas to the substantially constant temperature across the plurality of printing areas further comprises:
using empirical and thermal models related to the characteristic of the object to be produced by the three-dimensional printing to determine the fusing agent flux amount.

8. The method according to claim 1, further comprising:
determining a temperature associated with production of the object without use of the fusing agent flux amount of the fusing agent sufficient to oversaturate the at least one of the plurality of printing areas; and
increasing the temperature associated with the production of the object to the substantially constant temperature based on the use of the fusing agent flux amount of the fusing agent sufficient to oversaturate the at least one of the plurality of printing areas.

9. The method according to claim 1, wherein determining, based on the characteristic of the object to be produced by the three-dimensional printing, the fusing agent flux amount of the fusing agent sufficient to oversaturate the at least one of the plurality of printing areas to cool the at least one of the plurality of printing areas, and modulate the temperatures related to the plurality of printing areas to the substantially constant temperature across the plurality of printing areas further comprises:
determining the fusing agent flux amount of the fusing agent sufficient to obtain a specified optical density of the at least one of the plurality of printing areas.

10. The method according to claim 1, wherein determining, based on the characteristic of the object to be produced by the three-dimensional printing, the fusing agent flux amount of the fusing agent sufficient to oversaturate the at least one of the plurality of printing areas to cool the at least one of the plurality of printing areas, and modulate the temperatures related to the plurality of printing areas to the substantially constant temperature across the plurality of printing areas further comprises:
dividing the object to be produced into a plurality of shells including predetermined diameters, wherein each shell of the plurality of shells includes a predetermined thickness; and
for each shell of the plurality of shells, determining a different fusing agent flux amount of the fusing agent.

11. An apparatus for build temperature modulation, the apparatus comprising:
a processor; and
a memory storing machine readable instructions that when executed by the processor cause the processor to:
determine a characteristic of an object to be produced by three-dimensional printing, wherein the three-dimensional printing divides the object into a plurality of printing areas for producing the object by using a fusing agent; and
determine, based on the characteristic of the object to be produced by the three-dimensional printing,
a fusing agent flux amount of the fusing agent, and
application of a detailing agent that is to be used with the fusing agent,
wherein the fusing agent flux amount of the fusing agent and the application of the detailing agent are sufficient to oversaturate at least one of the plurality of printing areas to
cool the at least one of the plurality of printing areas, and
modulate temperatures related to the plurality of printing areas to a substantially constant temperature across the plurality of printing areas.

12. The apparatus according to claim 11, wherein the detailing agent includes a clear printing fluid or a colored printing fluid used to control temperature around a boundary of the at least one of the plurality of printing areas.

13. The apparatus according to claim 11, wherein the machine readable instructions to determine, based on the characteristic of the object to be produced by the three-dimensional printing, the fusing agent flux amount of the fusing agent, and the application of the detailing agent that is to be used with the fusing agent, further comprise machine readable instructions to:
use empirical and thermal models related to the characteristic of the object to be produced by the three-dimensional printing to determine the fusing agent flux amount.

14. A non-transitory computer readable medium having stored thereon machine readable instructions to provide build temperature modulation, the machine readable instructions, when executed, cause a processor to:
determine a characteristic of objects to be produced by three-dimensional printing, wherein the three-dimensional printing divides the objects into a plurality of printing areas for producing the objects by using a fusing agent; and
determine, based on the characteristic of the objects to be produced by the three-dimensional printing, a fusing agent flux amount of the fusing agent sufficient to oversaturate at least one of the plurality of printing areas to modulate temperatures related to the plurality of printing areas to a substantially constant temperature across the plurality of printing areas.

15. The non-transitory computer readable medium according to claim 14, wherein the machine readable instructions to determine, based on the characteristic of the objects to be produced by the three-dimensional printing, the fusing agent flux amount of the fusing agent sufficient to oversaturate the at least one of the plurality of printing areas to modulate the temperatures related to the plurality of printing areas to the substantially constant temperature across the plurality of printing areas, further comprise machine readable instructions to:
determine a relative size of the at least one of the plurality of printing areas compared to other printing areas of the plurality of printing areas; and
determine, based on the relative size, a higher fusing agent flux amount of the fusing agent for the at least one of the plurality of printing areas that includes a larger cross-sectional area compared to a printing area of the plurality of printing areas that includes a relatively smaller cross-sectional area, wherein the higher fusing agent flux amount is greater than a baseline fusing agent flux amount for the at least one of the plurality of printing areas that includes the larger cross-sectional area.
